(19) United States
(12) Patent Application Publication
(10) Pub. No.: US 2020/0065505 A1
(43) Pub. Date: Feb. 27, 2020

(54) SYSTEM AND METHOD FOR CROSS-ORIGIN SESSIONS

(71) Applicant: Genesys Telecommunications Laboratories, Inc., Daly City, CA (US)

(72) Inventor: Charles Wall, Durham, NC (US)

(21) Appl. No.: 16/112,458

(22) Filed: Aug. 24, 2018

(51) Int. Cl. G06F 21/62; H04L 29/06; H04L 12/58

(52) U.S. Cl. CPC G06F 21/62; H04L 51/04; H04L 65/403; H04L 63/108

(57) ABSTRACT

A system and method are presented for implementing cross-origin sessions in collaboration platforms. A webchat iframe may store data with an expiration and a list of domains that are able to access the iframe. Functionalities such as co-browse and webchat are enabled to work across navigation from one friendly domain to another friendly domain as a result. Browser restrictions may be circumnavigated that forbid webpages housed on different domains to share data. In an embodiment, a whitelist may be stored of potential accessors and a time to live with each datum. In an embodiment, data may be retrieved from the same origin or it may be retrieved from another origin. In another embodiment, data may be protected from unauthorized accessors.

### BACKGROUND

The present invention generally relates to telecommunications systems and methods, as well as web-browser technology. More particularly, the present invention pertains to information sharing utilizing web-browser technology.

### SUMMARY

A system and method are presented for implementing cross-origin sessions in collaboration platforms. A webchat iframe may store data with an expiration and a list of domains that are able to access the iframe. Functionalities such as co-browse and webchat are enabled to work across navigation from one friendly domain to another friendly domain as a result. Browser restrictions may be circumnavigated that forbid webpages housed on different domains to share data. In an embodiment, a whitelist may be stored of potential accessors and a time to live with each datum. In an embodiment, data may be retrieved from the same origin or it may be retrieved from another origin. In another embodiment, data may be protected from unauthorized accessors.

In one embodiment, a system is presented for implementing a cross-origin session in a collaboration platform for information sharing between a plurality of origins comprising: a processor; and a memory in communication with the processor, the memory storing instructions that, when executed by the processor, causes the processor to share information by: accessing a first origin of the plurality of origins by a user, wherein the accessing causes the first origin to create a storage origin; the first origin sending a message to the storage origin to store a datum with at least a second origin of the plurality of origins and the first origin having access capabilities; navigating by the user to the second origin; requesting, by the second origin, the datum from the storage origin; verifying by the storage origin that the second origin has access capabilities; and providing the datum to the second origin after the second origin has been verified, otherwise, not allowing access to the datum.

In another embodiment, a system is presented for implementing a shared-origin session in a collaboration platform for information sharing between a plurality of origins comprising: a processor; and a memory in communication with the processor, the memory storing instructions that, when executed by the processor, causes the processor to share information by: accessing a first origin of the plurality of origins by a user, wherein the accessing causes the first origin to create a storage origin within itself; the first origin sending a message to the storage origin to store a datum with at least a second origin of the plurality of origins and the first origin having access capabilities; navigating by the user to the second origin; requesting, by the second origin, the datum from the storage origin within the first origin; verifying by the first origin that the second origin has access capabilities; and providing the datum to the second origin after the second origin has been verified, otherwise, not allowing access to the datum.

### BRIEF DESCRIPTION OF THE DRAWINGS

FIG. 1 is a schematic diagram illustrating an embodiment of a shared-origin approach.

FIG. 2 is a schematic diagram illustrating an embodiment of a peer approach.

FIG. 3 is a schematic diagram illustrating an embodiment for protecting data from unauthorized domains.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Collaborative browsing, commonly referred to as ‘co-browse’, comprises joint navigation by at least two users accessing the same web page simultaneously through the world wide web. Co-browse is only able to function across a single origin and can only store information about the current session in local storage. An origin might comprise the combination of a Uniform Resource Identifier (URI) scheme, host name, and port number for a web-browser. As a result of the single origin functionality of co-browse, the stored information is restricted by the web browser and may only be accessed from the same origin.

Collaboration platforms for customer relationship management utilizing web browser technology, such as PureCloud® from Genesys Telecommunications Laboratories, Inc., to name a non-limiting example, comprising functionalities such as co-browse and webchat, need to be able to work across multiple origins. In an embodiment, the collaboration platform deployed in a contact center environment enables a user at an agent workstation to be able to interact with a contact (such as a customer) as well as across the business with other agents or employees. In an embodiment, the agent workstation may comprise a telephone adapted for regular telephone calls, VoIP calls, etc. The workstation may also comprise a computer for communication with servers and performing data processing associated with contact center operations and for interfacing with customers via voice and other multimedia communication mechanisms, such as webchat.

The contact may comprise a user (such as a customer) on their internet connected device (e.g., laptop, PC, smartphone, tablet, etc.) desiring to connect with the contact center. Interactions with between the agents and the customers may be omni-channel over the collaboration platform, such as through voice, webchat, social media, email, etc. In an embodiment, an agent and a customer may be interacting through the internet via webchat on a website. The website and its webpages are associated with an enterprise, wherein the enterprise is supported by the contact center the agent is associated with.

Scenarios may occur where different websites on different origins need to share information about a given user. In a contact center environment, to give a non-limiting example, a customer may want to share their view of a webpage or web application with an agent in the contact center. The customer may be accessing the web page or web application through a computing device (e.g., smartphone, tablet, computer, laptop, etc.) with connectivity to the internet. Once sharing begins between the customer and the agent, each party is able to see where the other clicks on the web page and has the ability to see each other's cursor movements.

Additionally, a co-browse session can be launched from an existing web chat interaction. There may be an unlimited number of participants in the interaction, however, for simplicity, two participants are described in this example. During the co-browse session the customer may be sharing their screen with the agent. Co-browse sends any changes to the origin's Document Object Model (DOM) to the collaboration platform. In an embodiment, co-browse uses this information to build the same page the sharer sees on the agent's screen seamlessly. Co-browse monitors for any changes on the page, such as scrolling, clicking, or text typed in a form field. When there is a change to the DOM, co-browse sends the change to the collaboration platform and updates the agent's view in real time. However, should the sharer change origins in the middle of the co-browse session (such as by navigating to a new web page), the session will fail.

The same functionality may also be used in webchat features within the collaborating platform. Using the scenario of an agent and a customer interaction within a contact center, the customer initiates a live chat with a customer service agent via webchat. The webchat user interface appears within the webpage and follows the customer as they traverse the website. In an embodiment, the customer may also initiate a co-browse session with an agent directly from webchat. Similar to the scenario described above for co-browse, should the participant to the webchat change origins in the middle of the session, the session will fail.

Two approaches may be used to implement cross-origin storage in order to prevent session failure: the cross-origin approach and the peer approach. With the cross-origin (also referred to as ‘shared’) origin approach, white-listing may be employed to keep the session from failing in the browser without the use of any server-side technology. White-listing, for example, comprises identifying entities that may be associated with a particular access or privileged. Those entities on the list may be granted access while those not on the list are denied access.

For example, if a first website (OriginA) wanted to share information with a second website (OriginB), OriginA could not access the same local storage as OriginB. In an embodiment, a site is developed that can be hosted on a common origin (the PureCloud® iframe, for example) for each origin to access information. The code comprises the client and also functions as the storage. This is described in greater detail further below.

In another embodiment, the peer (also referred to as ‘same-origin’) approach may be used. Continuing with a similar example as above, if OriginB wanted OriginA to access information, OriginB could store the information within itself with access given to OriginA. OriginA could then make a call into OriginB for that information. This may happen in the browser without any server-side technology, like the cross-origin approach described above.

The functionalities of the collaboration platform (e.g., webchat) may utilize both the peer approach and the shared-origin approach. Alternatively, the functionalities of the collaboration platform may utilize only one approach, such as the shared-origin approach, in the case of co-browse. Co-browse may be used in conjunction with a webchat or as a side channel with a call, or with neither. In an embodiment, the approach may be built into the webpage on the front-end and be customer facing. When a party joins the interaction, the system is able to identify the party through the various origins. The party is unauthenticated and the front-end is able to know the identities of the party, whereas the backend is unable to distinguish between known and unknown parties.

In an embodiment of the shared-origin approach, the iframe may store data with an expiration such that the stored information has a time to live. The iframe may also store a list of origins that can access the stored data, which also may have an expiration.

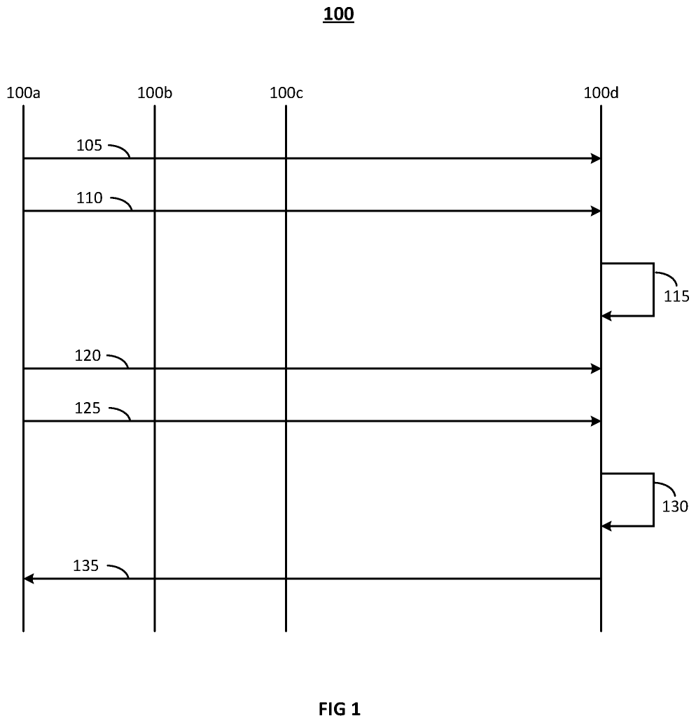

Co-browse and webchat functionalities can thus work across navigation from one friendly origin to another friendly origin. FIG. 1 illustrates a schematic diagram of an embodiment of this shared-origin approach, indicated generally at 100. This approach may be used by both co-browse and webchat.

The components of the approach comprise a plurality of web browsers. For illustrative purposes, three browsers are illustrated generally in FIG. 1: OriginA 100a, OriginB 100b, and OriginC 100c. A storageOrigin is also illustrated at 100d, which might comprise an iframe. OriginA 100a creates a webchat storage iframe 105. In an embodiment, this is performed through javascript. An html element is created which is an iframe. This may be triggered upon loading of the page when the user accesses OriginA 100a.

OriginA 100a sends a postMessage to the iframe to store a datum 110 with OriginB 100b able to have access. In an embodiment, PostMessages are used because the browser includes the origin where it originates and allows control of who is pulling information.

The webchat iframe 100d stores the datum in local storage referencing both OriginA 100a and OriginB 100b as potential accessors 115. There is a list (e.g., whitelist) of origins associated with the datum who are allowed to pull, or access, the datum. If an origin is not associated with the list, then it cannot pull the datum or know of its existence.

In an embodiment, when data is retrieved from a shared origin, OriginA 100a will similarly create a webchat storage iframe 120. In an embodiment, this is performed through javascript. An html element is created which is an iframe. This may be triggered upon loading of the page when the user accesses OriginA 100a. OriginA 100a sends a postMessage to the iframe 100d to request a datum 125. The webchat iframe performs a lookup function 130 to the accessor list in order to verify that OriginA 100a is on the accessor list. After OriginA 100a has been verified, the data is returned 135 to OriginA 100a from the iframe 100d.

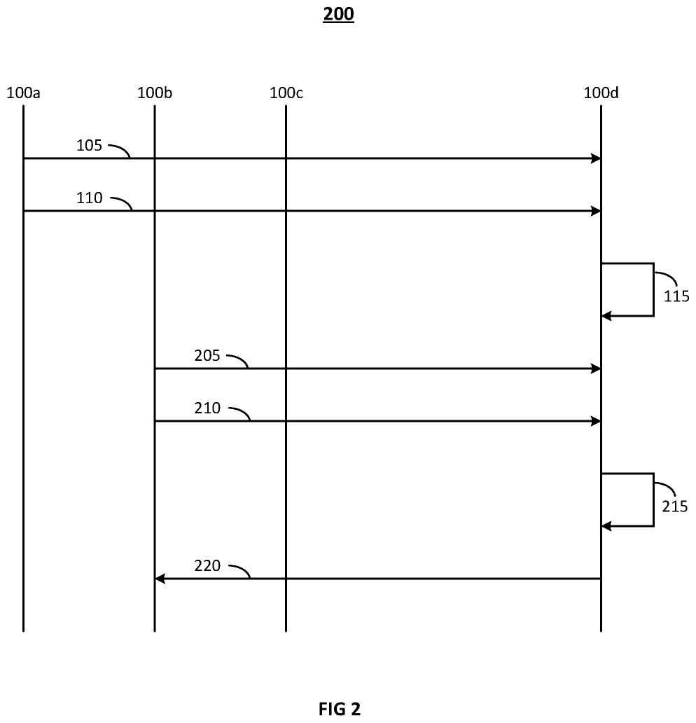

In the peer approach, the user may then navigate to OriginB 100b. An embodiment of the peer approach is indicated generally in FIG. 2, at 200. The peer approach may be used by webchat. In this example, OriginA 100a stores the datum on its own origin with permissions to OriginB 100b to access it. When the user accesses OriginB 100b, this event triggers the creation of a webchat storage iframe 100d by OriginB 100b, 205. OriginB 100b sends a postMessage to request the datum 210 that OriginA 100a has stored. The webchat iframe 100d verifies that OriginB 100b is a viable accessor of the datum and that it has not expired 215. Once the system has verified that OriginB 100b has access, the webchat iframe 100d sends a postMessage 220 to OriginB 100b with the datum.

In an embodiment, if an origin fails verification as an accessor, then no information will be returned and the origin might receive a message indicating that data is not found or that access has been denied. Cross-origin sessions include a way of verifying the origins of websites and to prevent just any website from the unauthorized pulling of information. Information may only be shared between the parties, prohibiting a third-party site from accessing the information. For example, third-party websites may be prevented from spying on browsing. Restrictions may also be placed on who and/or what has the ability to read the data across the entire internet.

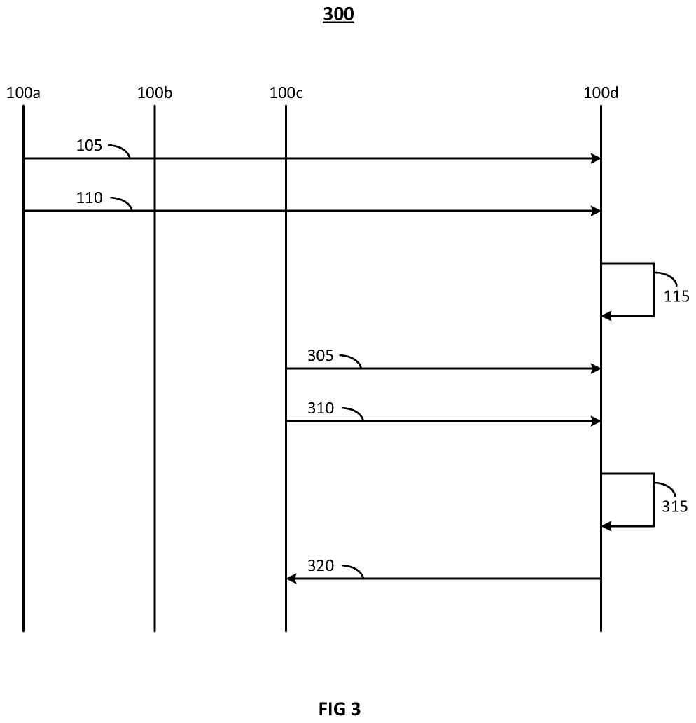

FIG. 3 illustrates an embodiment of a schematic diagram for protecting data from unauthorized domains, indicated generally at 300. OriginC 100c comprises a third party which has created an iframe to the storage origin 305. OriginC 100c has requested data 310 from the storage origin 100d as OriginC 100c. The iframe 100d performs a lookup and finds that OriginC 100c is not a viable accessor of the datum 315. Thus, OriginC 100c fails verification because OriginC 100c is not listed as an accessor. A message is returned 320 to OriginC 100c from the iframe 100d that data is not found. Alternatively, a denial of access message may be returned.

Within webchat, for example, origins may be verified, preventing reconnection issues in the event of disconnection. However, navigating by a user across origins will cause the chat to fail. For example, the user may navigate to a new page from their current page. When the new page is created, the user may wish to be able to reconnect back to the chat they are engaged in on the previous page, but the navigation has caused the chat to fail. A cross-origin session can allow the chat to continue. Origin validation may also be performed to verify the chat is shown in the right web page.

It should be noted that the previously described embodiments are not limited to webchat or co-browse functionalities. Cross-origin sessions may also be applicable to analytic tracking across multiple origins. For example, if a user wants to know which website another user wanted to visit, the first user could track anytime the second user loaded multiple websites using the technology. This information might be used to predict customer browsing habits. While cookies function similarly on websites, cookies are unable to function across multiple origins as the proposed methods herein are capable of.

In another example, data structures for passing information down a chain of origins may also be used. For example, http://*:genesys.com or *.genesys.com illustrate a chain representation of origins, where * can comprise any part of a domain provided the domain comprises the specified remainder. Access may also be controlled.

In another embodiment, companies or entities may have more than one domain or origin. A customer can move around on the site or family of sites to different webpages and still keep the chat alive. For example, a customer may be navigating across different websites within a family of brands owned by a parent company. A Genesys customer may wish to access their PureCloud® account on one website and check journey analytics through their ALTOCLOUD™ account (on a different website) while maintaining a chat with a technical support agent in the same web-browser as they navigate between websites.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A system for implementing a cross-origin session in a collaboration platform for information sharing between a plurality of origins comprising:
a processor; and
a memory in communication with the processor, the memory storing instructions that, when executed by the processor, causes the processor to share information by:
accessing a first origin of the plurality of origins by a user, wherein the accessing causes the first origin to create a storage origin;
the first origin sending a message to the storage origin to store a datum with at least a second origin of the plurality of origins and the first origin having access capabilities;
navigating by the user to the second origin;
requesting, by the second origin, the datum from the storage origin;
verifying by the storage origin that the second origin has access capabilities; and
providing the datum to the second origin after the second origin has been verified, otherwise, not allowing access to the datum.

2. The system of claim 1, wherein the collaboration platform comprises webchat.

3. The datum of claim 1, wherein the stored datum has an expiration for a time to live.

4. The datum of claim 1, wherein the stored datum has an expiration for the list of origins that can access the datum.

5. The system of claim 1, wherein the plurality of origins are each associated with websites.

6. The websites of claim 4, wherein the websites comprise webchat capabilities.

7. The system of claim 1, wherein the messages comprise postMessages.

8. The system of claim 1, wherein the storage origin comprises one or more iframes.

9. A system for implementing a shared-origin session in a collaboration platform for information sharing between a plurality of origins comprising:
a processor; and
a memory in communication with the processor, the memory storing instructions that, when executed by the processor, causes the processor to share information by:
accessing a first origin of the plurality of origins by a user, wherein the accessing causes the first origin to create a storage origin within itself;
the first origin sending a message to the storage origin to store a datum with at least a second origin of the plurality of origins and the first origin having access capabilities;
navigating by the user to the second origin;
requesting, by the second origin, the datum from the storage origin within the first origin;
verifying by the first origin that the second origin has access capabilities; and
providing the datum to the second origin after the second origin has been verified, otherwise, not allowing access to the datum.

10. The system of claim 9, wherein the collaboration platform comprises webchat.

11. The system of claim 9, wherein the collaboration platform comprises co-browse.

12. The datum of claim 9, wherein the stored datum has an expiration for a time to live.

13. The datum of claim 9, wherein the stored datum has an expiration for the list of origins that can access the datum.

14. The system of claim 9, wherein the plurality of origins are each associated with websites.

15. The websites of claim 14, wherein the websites comprise co-browse capabilities.

16. The system of claim 9, wherein the messages comprise postMessages.

17. The system of claim 9, wherein the storage origin comprises one or more iframes.
